(19) United States
(12) Patent Application Publication
(10) Pub. No.: US 2004/0085573 A1
(43) Pub. Date: May 6, 2004

(54) Printing accessory for mobile client device

(76) Inventor: Mohammad Reza Aidinejad, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/286,135

(22) Filed: Oct. 31, 2002

(51) Int. Cl. G06F 3/12; G06F 13/00

(52) U.S. Cl. 358/1.15; 455/66.1

(57) ABSTRACT

A printing accessory preferably includes a first interface for communicating with a mobile client device; a second interface for communicating with a printer; a processor for controlling the first and second interfaces; and a printer driver stored in memory for execution by the processor. The printing accessory is configured to receive data from a mobile client device through the first interface and convert the data into a print job which print job is output through the second interface.

### BACKGROUND OF THE INVENTION

With a personal computer and an appropriate software package, a user can produce virtually any type of document that may be desired. For example, word processing software is used to produce text documents. Graphic design or computer-aided design software can be used to produce diagrams, charts, graphs, designs, etc. Spreadsheet software allows a user to manage large amounts of financial and other types of information. Database software similarly allows a user to manage various databases of information such as, client contact information, address and phone number information or “to do” items.

Frequently, it is desirable to generate a hardcopy of a document or data set that is produced or stored on a personal computer. A hardcopy may be desired, for example, for record keeping purposes or to share with another party. Consequently, a wide variety of printers and printing devices have been developed that can receive a print job from a host computer and produce a hardcopy of the document or data represented by that print job.

As used herein and in the appended claims, the terms “printer” and “printing device” are defined to mean any device that produces a hardcopy from electronic data, including, but not limited to, laser printers, inkjet printers, dot matrix printers, plotters, facsimile machines, digital copiers, multi-function peripherals, and the like. A printer or printing device may produce images on a variety of print media that are in color or are monochromatic.

The term “print job” is defined as data that has been specifically formatted for submission to a particular printer from which the printer can generate a hardcopy representing an underlying data set from which the print job was created.

Most personal computers including programming that will be referred to generally as a “printer driver.” A printer driver is a piece of software or firmware that receives data or a document to be printed from an application running on the computer. The printer driver formats the data for use by a corresponding printer, i.e., creates a print job, and then transmits the print job to the printer. Using the print job, the printer can produce a hardcopy of the underlying data or document.

While a user can produce an original document or enter data on a personal computer that, it is also frequently the case that the user receives a data file from another computer for which a hardcopy is desired. With computer networks, including the Internet, it is now very common to share files or data electronically between computers. Generally, a computer and printer can produce a hardcopy of data just as easily if the underlying data was transmitted to the computer rather than generated on the computer. The printer driver simply formats the received data for use by the connected printer.

However, with the advent of more and more wireless and mobile electronic devices, it is now often the case that data or a document is not stored on a personal computer. For example, electronic data and documents may be received and stored on a wireless phone or a wireless personal digital assistant (PDA).

In particular, wireless phones are including an ever-increasing amount of functionality. For example, a wireless phone may store a database of contact information, including names, phone numbers, etc. A wireless phone may also be able to download and display documents from the Internet. Wireless PDA's may also provide these and similar functions.

Unfortunately, if a hardcopy is desired of the data or document stored on a wireless phone, for example, there may be no way to readily produce the desired hardcopy. A user could re-enter or recreate the data stored on the wireless phone using a personal computer and then print a hardcopy from the computer, but such a process would obviously be tedious.

Similarly, a digital camera will take and store electronic photographs, creating an electronic file within the camera for each photo. However, it may be difficult to then generate hardcopies of those photographs. Typically some storage medium is provided that can be used to transfer the photograph files to a personal computer for eventual printing.

### SUMMARY OF THE INVENTION

In one of many possible embodiments, the present invention provides a printing accessory having a first, wireless interface for communicating with a mobile client device; a second interface for communicating with a printer; a processor for controlling the first and second interfaces; and a printer driver stored in memory for execution by the processor. The printing accessory is configured to receive data from a mobile client device through the first interface and convert the data into a print job, which print job is output through the second interface

In another embodiment, a system for printing data from a mobile client device includes a mobile client device having a wireless transceiver and a printing accessory having a wireless transceiver for communicating with the mobile client device. The mobile client device is configured to transmit data to the printing accessory, and the printing accessory is configured to generate a print job based on the data from the mobile client device.

In another embodiment, a printing accessory includes a first interface for communicating with a mobile client device, a second interface for communicating with a printer, a processor for controlling the first and second interfaces and a printer driver stored in memory for execution by the processor. The printing accessory is not, and does not comprise, a general purpose computer. The printing accessory is configured to receive data from a mobile client device through the first interface and convert the data into a print job which print job is output through the second interface.

In another embodiment, a method of generating a hardcopy of data stored on a mobile client device includes transmitting data wirelessly from the mobile client device to a printing accessory and generating a print job based on the data from the mobile client device with the printing accessory.

In another embodiment, a method of generating a hardcopy of data stored on a mobile client device includes transmitting data from the mobile client device to a printing accessory, where the printing accessory does not comprise a general purpose computer; and generating a print job based on the data from the mobile client device with the printing accessory.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram of one embodiment that includes a mobile client device, printing accessory and printer.

FIG. 2 is a block diagram illustrating further details of the internal components of the embodiment illustrated in FIG. 1.

FIG. 3 is flowchart illustrating the operation of, for example, the system illustrated in FIG. 1 according to one embodiment of the present invention.

FIGS. 4a-4e illustrate portions of a user interface that can be used, for example, with the printing accessory of FIG. 1 according to an embodiment of the present invention.

FIG. 5 illustrates portions of an alternative user interface that can be used, for example, with the printing accessory of FIG. 1 according to another embodiment of the present invention.

Throughout the drawings, identical reference numbers designate similar, but not necessarily identical, elements.

### DETAILED DESCRIPTION OF EMBODIMENTS OF THE INVENTION

As used herein and in the appended claims, the term “mobile client device” is defined as a mobile or portable electronic device that can generate or receive data or a document which a user may wish to have in hardcopy form, but which device does not have the capability to produce a print job that can be transmitted to a printer. Consequently, “mobile client devices” include, but are not limited to, wireless phones, digital cameras, personal digital assistants, digital wristwatches, etc.

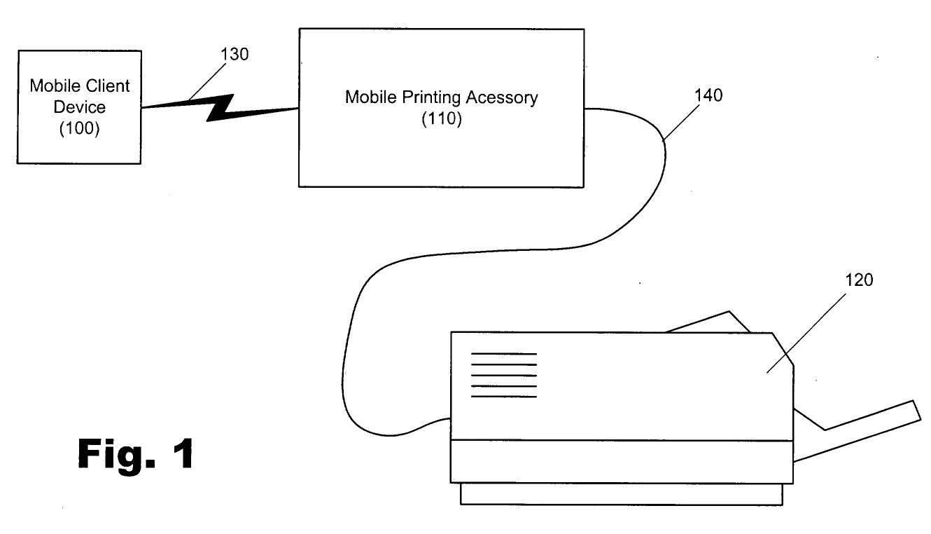

FIG. 1 is a block diagram of a mobile client device (100), a printing accessory (110) and a printer (120). As shown in FIG. 1, the mobile client device (100) transmits data to the printing accessory (110). Preferably, the communication link or interface (130) between the mobile client device (100) and the printing accessory (110) is wireless. For example, the interface (130) may operate according to the Bluetooth or other wireless protocol. The interface (130) will also preferably support hyper-text markup language (HTML) data.

It is possible to provide a wired link between the mobile client device (100) and the printing accessory (110). A wired link can accommodate large files for which wireless data transfer may be too slow, or may be preferred in cases where secure communication. In some embodiments, a Universal Serial Bus cable is preferably used to connect the mobile client device (100) to the mobile printing accessory (110). The accessory (110) can preferably recognize at least some mobile client devices automatically through “hot plug and play” techniques and then receive data for printing.

As noted above, the mobile client device (100) does not include the capability to prepare a print job for submission to a printer. This may be at least partially due to the memory, size, power and/or cost constraints on the mobile client device (100). Consequently, the mobile client device (100) transmits data that is stored on the mobile client device (100) over the interface (130) to the printing accessory (110).

The printing accessory (110) receives the data from the mobile client device (100). This data may include one or more documents or files, e-mails, e-mail attachments, data structures or the like. The printing accessory (110) may be equipped to receive data in any conceivable form or format. The printing accessory (110) then provides the functionality to format the received data, preferably under the control of a user through a user interface, into a print job that can be transmitted to a printer.

The printing accessory (110) can be interfaced with a printer (120). In some embodiments, the interface between the printer (120) and printing accessory (110) is through a cable (140). The cable (140) may be, for example, a Universal Serial Bus (USB) cable or a parallel cable. Many printers (120) have a ports, such as a USB or parallel port, to which the cable (140) can be readily connected. However, it is possible to create a wireless interface between the printing accessory (110) and the printer (120).

With the printing accessory (110) in communication with the printer (120), the printing accessory (110) can send a print job to the printer (120) that represents the data received from the mobile client device (100). The printer (120) can then produce a hardcopy from the received print job. In this way, data generated or stored on the mobile client device (100) can be easily rendered into hardcopy form.

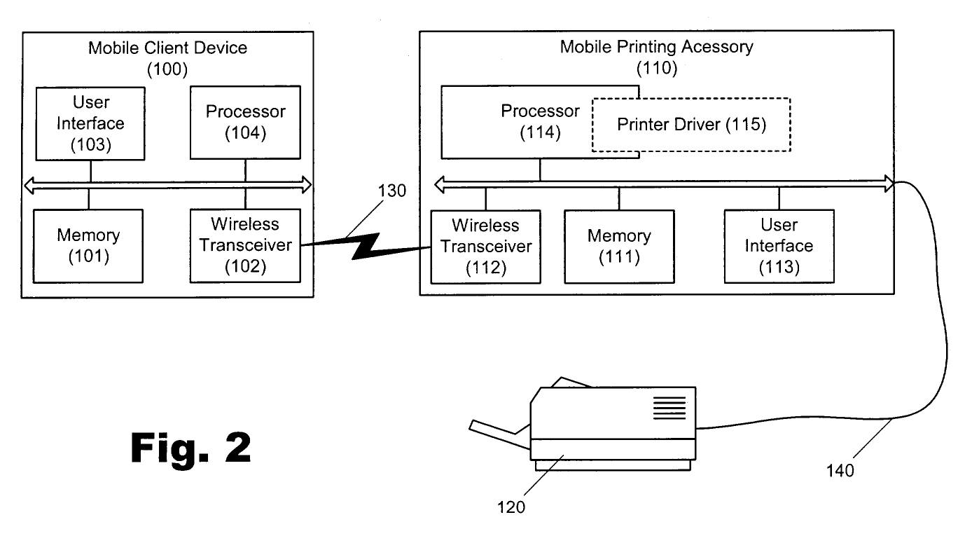

FIG. 2 is a block diagram illustrating further details of the internal components of the embodiment illustrated in FIG. 1. As shown in FIG. 2, a typical mobile client device (100) will include a processor (104) that controls the operation and functionality of the device (100). Data, including programming for the processor (104), can be stored in the memory unit (101). The data, documents or files that are generated on, or received by, the client device (100) will also be stored in the memory (101). The memory (101) may be divided into non-volatile memory and volatile memory, e.g., Random Access Memory (RAM).

A user interface (103) may include, for example, a display device, such as a liquid crystal display. The user interface (103) may also include user input devices such as one or more buttons, a keypad, touchpad, trackball, dial and the like. In some client devices, the display device and user input device may be combined as, for example, a touch-screen.

The mobile client device (100) also preferably includes a wireless transceiver (102). This transceiver (102), as shown in FIG. 2, is used to transmit data from the memory (101) of the client device (100) to the printing accessory (110). This may be the only function of the transceiver (102), if, for example, the client device (100) is a digital camera. Alternatively, the transceiver (102) may have other uses, such as, for example, communicating with a wireless network if the client device (100) is a wireless phone or wireless PDA. The wireless transceiver (102) may be any type of wireless transceiver, for example, an infrared transceiver or a radio frequency (RF) transceiver.

Preferably, the user of the client device (100) can initiate and control the transmission of data from the client device (100) to the printing accessory (110). The user interface (103) allows the user to control the transmission of data from the client device (100).

As described, the printing accessory (110) will receive the data from the mobile client device (100). Consequently, the printing accessory (112) includes a wireless transceiver (112) for communicating with the client device (100). The printing accessory (110) may actually include a number of different wireless transceivers so as to be able to communicate with a variety of client devices that use different wireless means of communication. It should also be remembered that the data link between the client device (100) and the mobile printing device (110) can be a wired connection.

The printing accessory (110) includes a processor (114), which controls the operation and functionality of the printing accessory (110). Data, including programming for the processor (114), can be stored in the memory unit (111). The data, documents or files that are received from the client device (100) will also be stored in the memory (111). The memory (111) may be divided into non-volatile memory and volatile memory, e.g., Random Access Memory (RAM).

In addition to, or as a component of, the firmware used by the processor (114) to operate the printing accessory (110), the processor (114) runs a printer driver (115) that processes and formats data received from a client device (100) into a print job. The print job is then transmitted over the cable (140) to the printer (120). The printer (120) receives the print job and outputs the print job in hardcopy form.

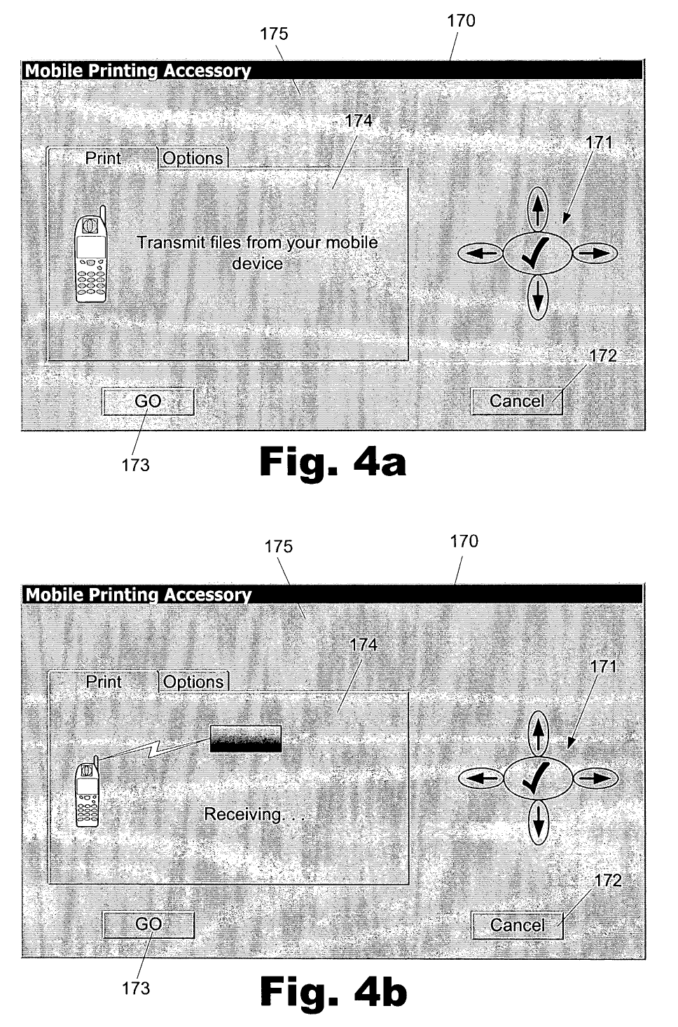

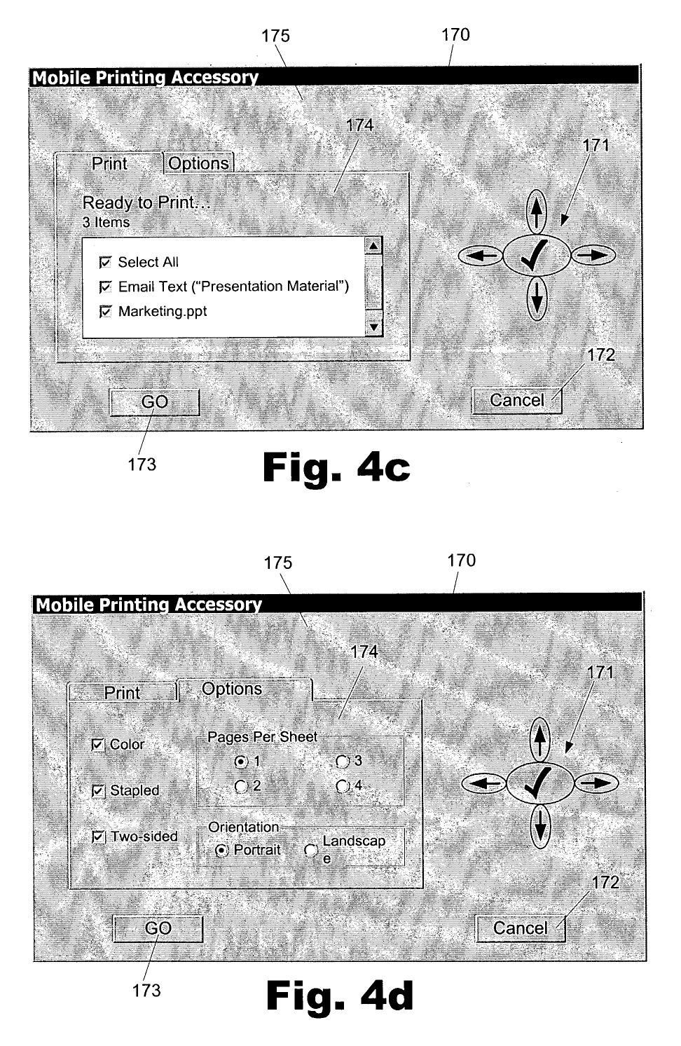

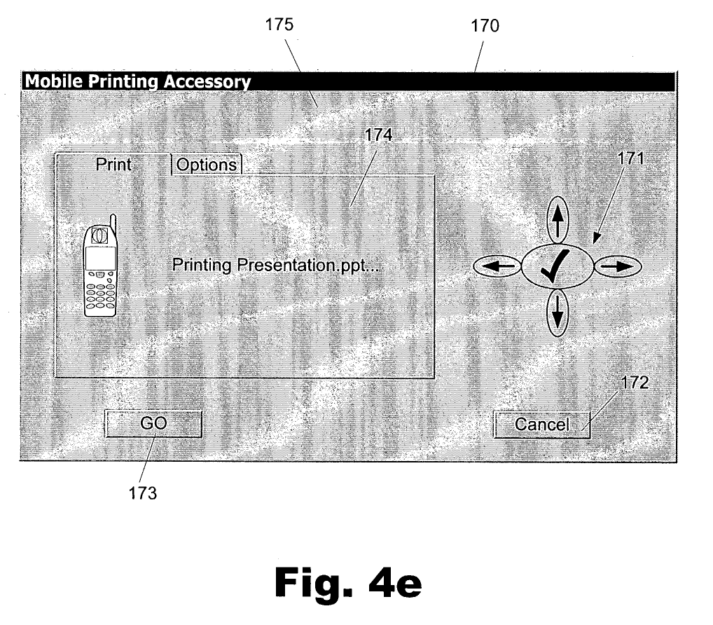

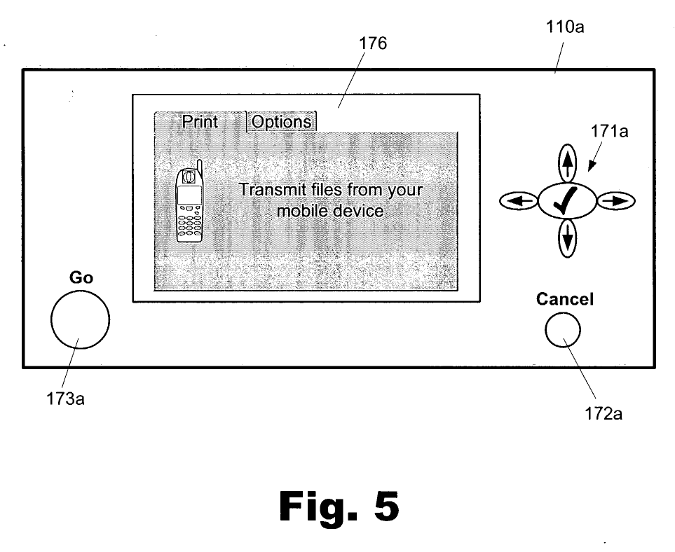

A user interface (113) is provided to allow a user to control the operation of the printing accessory (110). As before, the user interface (113) may include, for example, a display device, such as a liquid crystal display. The user interface (113) may also include user input devices such as one or more buttons, a keypad, touchpad, trackball, dial and the like. In some mobile printing accessories (110), the display device and user input device may be combined as, for example, a touch-screen. Additional details about possible embodiments of the user interface (113) will be discussed below in connection with FIGS. 4 and 5.

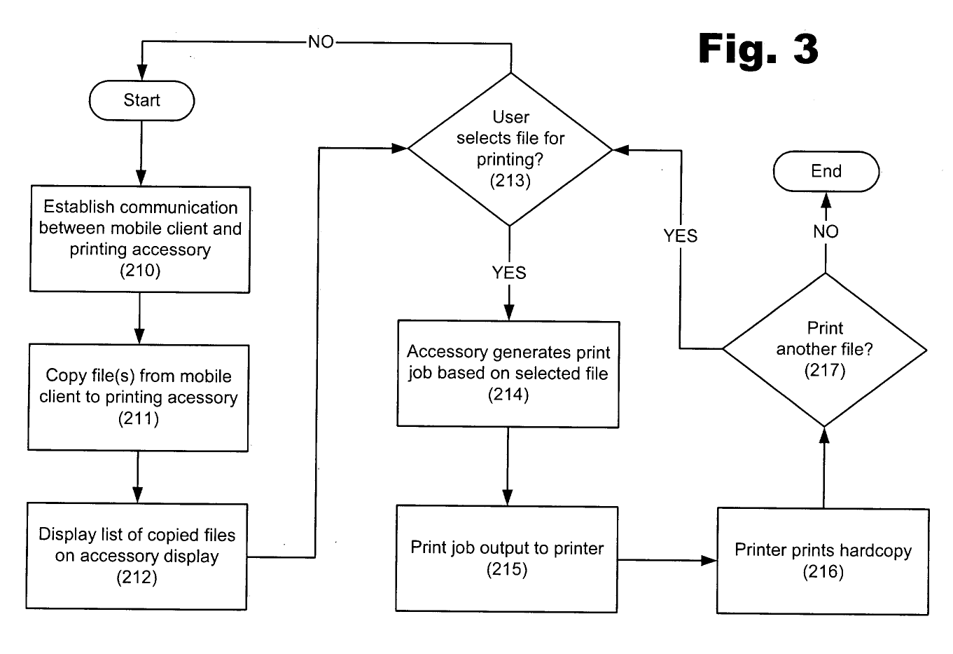

FIG. 3 is flowchart illustrating the operation of the system illustrated in FIG. 1, for example. As shown in FIG. 3, communication between the mobile client device and the printing accessory is first established. (Step 210).

Next, data files are copied from the mobile client to the printing accessory. (Step 211). The printing accessory then preferably displays a listing of the files (data, documents, etc.) obtained from the client device. (Step 212).

Using the user interface of the printing accessory, the user may then select files for printing from among the files listed. (Determination 213). The printing accessory then generates a print job or print jobs based on the file or files selected for printing. (Step 214).

The print job or jobs are then transmitted to the printer with which the printing accessory is communicating. (Step 215). The printer receives the print job(s) and prints one or more hardcopies based on the details of the print job. (Step 216). In this way, the data, document, file, etc. from the mobile client device is easily rendered into hardcopy form when needed.

The user may then have the option of printing one or more other files. (Determination 217). If no further printing is desired, the process ends. Otherwise, the user can selected additional downloaded data for printing or can re-establish communication between the same or a different mobile client device and the printing accessory and restart the process by receiving additional data from that client device.

FIGS. 4a-4e illustrate portions of a user interface that can be used, for example, with the printing accessory of FIG. 1. As indicated above, in some embodiments the user interface of the printing accessory may be a touch-screen that can both display information and receive user input. FIGS. 4a-4e illustrate a user interface for a printing accessory that includes a touch-screen (170).

As shown in FIG. 4a, the display (175) on the touch-screen (170) preferably includes a status display (174), a navigation keypad (171), and other buttons (e.g., 172, 173). As will be appreciated that, in this embodiment, the navigation keypad (171) and other buttons (e.g., 172, 173) are elements displayed on the touch-screen (170).

With the navigation keypad (171), the user can move a cursor or highlight using the arrow keys and make selections using the check key. The activity being conducted is preferably displayed in the status display (174). The other buttons are preferably a “Go” button (173) to initiate data input or printing of a selected data file and a “Cancel” button (172) to cancel an operation being conducted such as execution of a print job, establishing communication with a mobile client device, copying files from a client device, etc.

In FIG. 4a, the status display (174) prompts the user to initiate the transmission of files from the mobile client device. As shown in FIG. 4b, the status display (174) can indicate that a communication link is being established between the mobile client device and the printing accessory or that data is being copied from the mobile client to the printing accessory.

As shown in FIG. 4c, the status display (174) can then show a listing of data files received from the client device. Using the navigation keypad (171), the user can move through the listing and select files for printing. To assist, the listing may preferably include an option, “Select All” that will allow the user to select all listed files for printing with one action. The user then selects the “Go” button (173).

As shown in FIG. 4d, the status display (174) may then allow the user to control details of the printing. For example, multiple pages may be reduced in size to fit on a single sheet of print medium (“Pages Per Sheet”). The user may also select the orientation of the printed image, “Portrait” or “Landscape,” on the print medium. If color printing, stapling and/or two-sided (duplex) printing or other features are supported by the printer, these options can also be offered to the user. Any options available on the printer can be offered to the user through a interface screen such as then illustrated in FIG. 4d. Again, the user then selects the “Go” button (173).

As shown in FIG. 4e, the printing accessory then generates a print job or jobs for the selected data files and transmits the print job or jobs to the printer. The status display (174) preferably displays the current action and status of each print job. The printer then receives and prints the print jobs generated by the printing accessory.

FIG. 5 illustrates portions of an alternative user interface that can be used, for example, with the printing accessory of FIG. 1 according to another embodiment of the present invention. As shown in FIG. 5, the user interface of the printing accessory (110a) need not include a touch-screen. Rather, the user interface may include a display device (176), such as a liquid crystal display. The display device (176) preferably displays the prompts, user input templates, and status information similar to those displayed in the status display (174) of the embodiment of FIGS. 4a-4e.

The other elements of the user interface are physical buttons, a joystick, trackpad, trackball, keypad, dial or other user input devices. For example, a navigation keypad (171a) is preferably provided. This keypad (171a) is a physical keypad incorporated into an exterior of the printing accessory (110a) housing. Similarly, physical buttons are provided for the “Go” button (173a) and the “Cancel” button (172a). The functionality of these buttons, however, may be the same as the virtual “Go” and “Cancel” buttons in the embodiment of FIGS. 4a-4e.

Additionally, the user interfaces described above may not be located exclusively with the printing accessory. For example, if the mobile client has a sufficient user interface to support the functionality of the mobile printing device, the elements of the user interface described in the various embodiments above may be on the mobile client device. The client device then communicates user input and selections to the printing accessory over the interface between the two devices.

For example, a PDA with a touch-screen could receive and display the user interface elements illustrated in FIGS. 4a-4e. User input and selections could then be communicated back to the printing accessory.

In another example, a wireless phone could display user prompts and information similar to that illustrated in the status display (174; FIGS. 4a-4e). The keypad of the phone could then be used to make selections and issue commands that are then transmitted back to the printing accessory.

Consequently, the printing accessory may make use of the user interface on the mobile client device. Thus, the printing accessory need not necessarily include a user interface.

Alternatively, the user interface for the printing accessory could include a remote control unit. Such a remote control unit could incorporate both a display device and user input devices, or a touch-screen.

It should be noted that the printing accessory (110) is specifically designed to provide an interface between mobile client devices and a printer. Consequently, the accessory (110) is preferably designed to be small and lightweight for easy portability and preferably does not include extraneous elements beyond those needed for its core purpose. For example, the simplified user interfaces described above are preferred. The printing accessory (110) preferably does not include any larger user-interface elements such as a full alphanumeric keyboard. The printing accessory (110) also preferably does not include extraneous elements such as an optical or floppy disk drive.

The printing accessory (110) is not, and does not comprise, a general purpose computer. As used herein and in the appended claims, a “general purpose computer” is defined as a computer having one or more storage medium reading devices, such as a optical or floppy disk drive, with which an end user can install additional programming in available non-volatile memory and thereby create new functionality. Examples of general purpose computers include desktops, laptops, notebooks or tablet computers. It is not intended that the printing accessory (110) replace or provide the functionality of a general purpose computer or a portable personal computer.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A printing accessory comprising:
a first, wireless interface for communicating with a mobile client device;
a second interface for communicating with a printer;
a processor for controlling said first and second interfaces; and
a printer driver stored in memory for execution by said processor;
wherein said printing accessory is configured to receive data from a mobile client device through said first interface and convert the data into a print job which print job is output through said second interface.

2. The printing accessory of claim 1, further comprising a user interface allowing a user to control said printing accessory.

3. The printing accessory of claim 2, wherein said user interface comprises a touch-screen.

4. The printing accessory of claim 3, wherein said touch-screen displays a navigation keypad and a status display.

5. The printing accessory of claim 2, wherein said user interface comprises:
a display device; and
at least one user input device.

6. The printing accessory of claim 5, wherein said at least one user input device comprises a navigation keypad.

7. The printing accessory of claim 1, wherein said second interface comprises a cable for connecting said printing accessory and a printer.

8. The printing accessory of claim 7, wherein said cable is a Universal Serial Bus cable.

9. The printing accessory of claim 7, wherein said cable is a parallel cable.

10. A system for printing data from a mobile client device, said system comprising:
a mobile client device comprising a wireless transceiver; and
a printing accessory comprising a wireless transceiver for communicating with said mobile client device;
wherein said mobile client device is configured to transmit data to said printing accessory, said printing accessory is configured to generate a print job based on the data from said mobile client device.

11. The system of claim 10, further comprising a printer in communication with said printing accessory for receiving and printing said print job.

12. The system of claim 10, wherein said mobile client device comprises a wireless telephone.

13. The system of claim 10, wherein said mobile client device comprises a personal digital assistant.

14. The system of claim 10, wherein said mobile client device comprises a digital camera.

15. The system of claim 10, further comprising a user interface incorporated in said printing accessory for controlling said printing accessory.

16. The system of claim 10, further comprising a user interface incorporated in said mobile client device, said user interface configured to control said printing accessory.

17. The system of claim 16, further comprising a user interface incorporated in said printing accessory for controlling said printing accessory.

18. The system of claim 10, wherein said printing accessory further comprises a processor for executing a printer driver that generates said print job.

19. The system of claim 11, further comprising a cable for connecting said printing accessory with the printer.

20. The system of claim 11, further comprising a wireless interface between said printing accessory and the printer.

21. A method of generating a hardcopy of data stored on a mobile client device, said method comprising:
transmitting data wirelessly from said mobile client device to a printing accessory; and
generating a print job based on said data from said mobile client device with said printing accessory.

22. The method of claim 21, further comprising transmitting said print job to a printer from said printing accessory.

23. The method of claim 22, further comprising printing said print job to produce a hardcopy.

24. The method of claim 21, further comprising controlling said printing accessory with a user input device of said printing accessory.

25. The method of claim 21, further comprising controlling said printing accessory with a user input device of said mobile client device.

26. The method of claim 21, further comprising, with said mobile client device, initiating a wireless data link with said printing accessory.

27. The method of claim 21, further comprising display a listing of data files received by said printing accessory from said mobile client device.

28. The method of claim 27, further comprising selecting a data file to print from said listing.

28. The method of claim 22, further comprising printing said print job to produce a hardcopy.

29. A system for generating a hardcopy of data stored on a mobile client device, said system comprising:
means for transmitting data wirelessly from said mobile client device to a printing accessory; and
means for generating a print job in said printing accessory based on said data from said mobile client device.

30. The system of claim 29, further comprising means for transmitting said print job to a printer from said printing accessory.

31. The system of claim 30, further comprising printing said print job with said printer to produce a hardcopy.

32. The system of claim 30, further comprising means for controlling said printing accessory.

33. A printing accessory comprising:
a first interface for communicating with a mobile client device;
a second interface for communicating with a printer;
a processor for controlling said first and second interfaces; and
a printer driver stored in memory for execution by said processor;
wherein said printing accessory does not comprise a general purpose computer; and
wherein said printing accessory is configured to receive data from a mobile client device through said first interface and convert the data into a print job which print job is output through said second interface.

34. The printing accessory of claim 33, further comprising a user interface allowing a user to control said printing accessory.

35. The printing accessory of claim 34, wherein said user interface comprises a touch-screen.

36. The printing accessory of claim 34, wherein said user interface comprises:
a display device; and
at least one user input device.

37. The printing accessory of claim 33, wherein said first interface comprises a cable for connecting said mobile client device and said printing accessory.

38. The printing accessory of claim 33, wherein said second interface comprises a cable for connecting said printing accessory and a printer.

39. A method of generating a hardcopy of data stored on a mobile client device, said method comprising:
transmitting data from said mobile client device to a printing accessory, wherein said printing accessory does not comprise a general purpose computer; and
generating a print job based on said data from said mobile client device with said printing accessory.

40. The method of claim 39, further comprising transmitting said print job to a printer from said printing accessory.

41. The method of claim 40, further comprising printing said print job to produce a hardcopy.

42. The method of claim 39, further comprising controlling said printing accessory with a user input device of said printing accessory.

43. The method of claim 39, further comprising controlling said printing accessory with a user input device of said mobile client device.
